(19) United States
(12) Patent Application Publication
(10) Pub. No.: US 2015/0180950 A1
(43) Pub. Date: Jun. 25, 2015

(54) TEST MANAGEMENT USING DISTRIBUTED COMPUTING

(71) Applicant: International Business Machines Corporation, Armonk, NY (US)

(72) Inventors: Hiroo Hishioka, Benowa (AU); Andrew Larsen, Palm Beach (AU); Gregory O. McCane, Palm Beach (AU); Anand Rathi, Southport (AU); Alexander Starostin, Maudsland (AU)

(21) Appl. No.: 14/479,645

(22) Filed: Sep. 8, 2014

Related U.S. Application Data
(63) Continuation of application No. 14/133,948, filed on Dec. 19, 2013.

(51) Int. Cl. H04L 29/08

(52) U.S. Cl. CPC H04L 67/10

(57) ABSTRACT

Embodiments of the present invention relate to test management using distributed computing. A computing device transmits a test job to a test client for servicing, wherein the test client has an idle resource. The computing device receives results of the test job servicing from the test client, wherein the test job includes computer code that is under development and predefined information that reflects how the test client is to execute the test job.

### BACKGROUND

The present disclosure relates generally to the field of test management, and more particularly to test management using distributed computing.

Grid computing involves a collection of computer resources from multiple locations that work together to reach a common goal. The grid can be thought of as a distributed system with non-interactive workloads that involve a large number of files. Distributed computing involves multiple remotely located computers wherein each computer participates in a computation problem or information processing. Grid computing is distinguished from conventional high-performance computing systems, such as cluster computing, because grids tend to be more loosely coupled, heterogeneous, and geographically dispersed.

Contemporary software development methods often include agile software development methods, which require comprehensible automated test suites that are run every time the product code is changed. Most development teams implement this requirement by deploying multiple high-powered build servers that are dedicated to building and testing the product. Such servers represent a significant capital and operational cost. Running comprehensive automated test suites on medium to large software projects can often take over twenty-four (24) hours. A test manager is often utilized to manage the computer software testing process. A test manager manages tests (automatically or manually) that have been previously specified by a test procedure.

### SUMMARY

Embodiments of the present invention relate to test management using distributed computing. A computing device transmits a test job to a test client for servicing, wherein the test client has an idle resource. The computing device receives results of the test job servicing from the test client, wherein the test job includes computer code that is under development and predefined information that reflects how the test client is to execute the test job.

### BRIEF DESCRIPTION OF THE SEVERAL VIEWS OF THE DRAWINGS

FIG. 1 is a block diagram illustrating an environment, in accordance with an embodiment of the present invention.

FIG. 2 is a depiction of various push/pull cycles and transmissions between the test server, test client, and system under test of FIG. 1, in accordance with an embodiment of the present invention.

FIG. 3 is a flowchart depicting operational steps of a program function, in accordance with an embodiment of the present invention.

FIG. 4 depicts a block diagram of components of the test server and test client, in accordance with an embodiment of the present invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (hereinafter “RAM”), a read-only memory (hereinafter “ROM”), an erasable programmable read-only memory (hereinafter “EPROM” or “Flash memory”), an optical fiber, a portable compact disc read-only memory (hereinafter “CD-ROM”), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (hereinafter “LAN”) or a wide area network (hereinafter “WAN”), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

To reduce the elapsed time taken to run comprehensive automated test suites during software development, comprehensive automated test suites are run when product code is changed. Deploying multiple high-powered build servers that are dedicated to building and testing the product can represent a significant capital and operational cost. Running comprehensive automated test suites on medium to large software projects can take over twenty-four (24) hours. Embodiments of the present invention seek to reduce this elapsed time by decreasing the time it takes to provide feedback on the state of the code, thus enabling any defects to be rectified more efficiently.

To address this concern, embodiments of the present invention seek to distribute test jobs as part of a test suit to idle computing resources, such as CPUs and/or networks, for servicing, wherein the idle resources are part of a heterogenous computer grid. Briefly, participating test clients have test agent engines pre-installed by a user that notifies the test server when the test client is availed to service test jobs. The test server sends test jobs to available test clients for servicing and records test results. In certain embodiments, test agent engines are installed automatically without user intervention. In an embodiment, processes associated with test agents and/or the servicing of test jobs are given a lower scheduling priority such that test client performance degradation can be minimized. The test agent notifies the test server of the test client's system configuration and ready status. The test agent executes test jobs according to instructions included in the test job and transmits the test results to the test server. In an embodiment, the test job includes predefined information reflective of how the test client is to execute the test job.

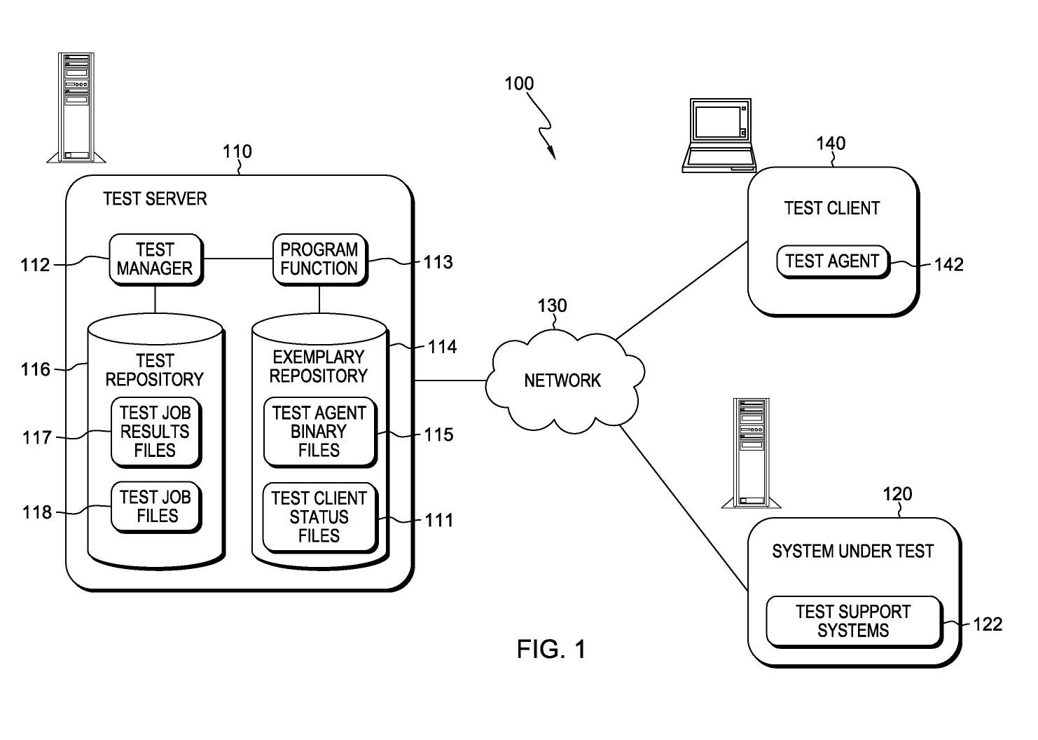

Embodiments of the present invention will now be described in detail with reference to the Figures. FIG. 1 is a block diagram illustrating an environment, generally designated 100, in accordance with one embodiment of the present invention. FIG. 1 is an exemplary illustration of an environment, generally 100, in accordance with an embodiment of the present invention. Environment 100 is an environment that supports using idle computer resources present in a computer grid for software development, in accordance with an embodiment of the present invention. Environment 100 is comprised of a collection of computing resources from multiple locations, such as a computer grid. Environment 100 includes test server 110, system under test (hereinafter “SUT”) 120, and test client 140 all interconnected over network 130. Environment 100, in one embodiment, includes a collection of heterogenous computing systems, or even heterogenous test clients, each configured for testing according to the techniques introduced herein. Network 130 can be, for example, a local area network (hereinafter “LAN”), a wide area network (hereinafter “WAN”), such as the Internet, or a combination of the two, and can include wired, wireless, or fiber optic connections. In general, network 130 can be any combination of connections and protocols that will support communications between test server 110, SUT 120, and test client 140.

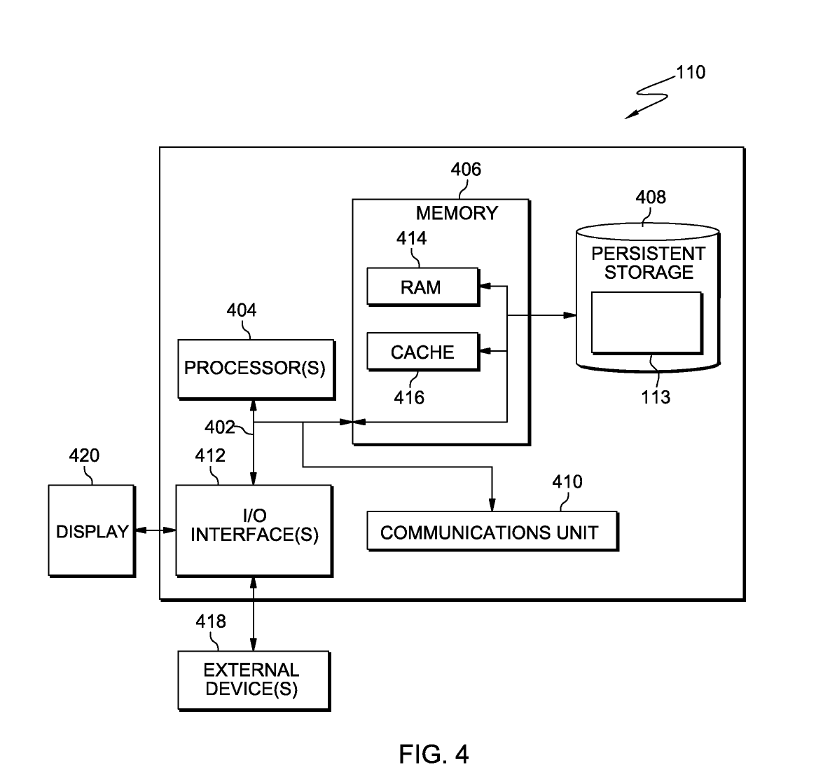

In various embodiments of the present invention, each one of test server 110, SUT 120, and test client 140 may be a laptop computer, a tablet computer, a netbook computer, a personal computer (hereinafter “PC”), a desktop computer, a personal digital assistant (hereinafter “PDA”), a smart phone, or any programmable electronic device. Test server 110, test client 140, and system under test 120 may include internal and external hardware components, as depicted and described in further detail with respect to FIG. 4. In an embodiment, test client 140 is a virtual machine. SUT 120 is in communication with network 130 and includes test support systems 122, which are systems that may be required to service the test job, such as a database. In certain embodiments, test support systems 122 are external to SUT 120 and/or in communication with network 130. SUT 120 is a system that is being tested for correct operation, in accordance with an embodiment of the present invention.

Test client 140 is in communication with network 130, in accordance with an embodiment of the present invention. Test client 140 is a computing device that is used to service test jobs using its idle CPUs. In certain embodiments, test client 140 is included in an idle network. Test client 140 includes test agent 142, which can be pre-installed by a user. Test agent 142 is necessary for servicing test jobs received from test server 110. Test agent 142 services test jobs when CPU usage percentage falls below a predetermined value, for example 5%. Test agent 142 transmits test results to test manager 112 (discussed below) via network 130. Test agent 142 transmits the availability of test client 140 to service test jobs (hereinafter “ready status”) to program function 113.

Test server 110 is in communication with network 130. Test server 110 is a computing device that generates and transmits test jobs for servicing, in accordance with an embodiment of the present invention. Test server 110 can include test repository 116, test manager 112, exemplary repository 114, and program function 113. Test repository 116 can include test job files 118 and test job results files 117. Test job files 118 can include test code and predefined test instructions that reflect steps to test the test code. In an embodiment, test job files 118 include predefined information that reflects how test client 140 is to execute test job files 118. In certain embodiments, test job files 118 boots a SUT that is associated with the test job. In an embodiment, the predefined test instructions are generated by test manager 112. The predefined test instructions can also define the SUT, such as SUT 120, and any associated test support systems (hereinafter “TSS”), such as TSS 122 (discussed below). Test job results files 117 include test results generated by test agent 142 as a result of servicing test job files 118.

Test manager 112 is in communication with program function 113 and test repository 116. Test manager 112 is software that manages the testing of test code. Test manager 112 can generate test jobs, such as those included in test jobs files 118, for servicing by test agent 142. Test manager 112 can select the test type to run. Test manger 112 generates a test report that presents the outcome of the test job run. Test manager 112 can store outcomes of test job runs in test job results files 117. Test manager 112 is in communication with test manager 112 and exemplary repository 114. Test manager 112 can transmit test jobs to test clients having idle resources, such as CPUs and networks. Exemplary repository 114 is an information store that includes test client status files 111, which reflects the ready status (discussed above) of test client 140, and test agent binary files 115, which includes test agent code for downloading to test clients.

Test agents included in test agent binary files 115 can service one or more types of test jobs, such as those included in test job files 118. Once a test agent binary file is downloaded, for example, to test client 140, information included in the file is installed and becomes test agent 142. Program function 113 is software that provides test agents to test clients to service test jobs, in accordance with an embodiment of the present invention. Program function 113 can transmit test agent binary files 115 to test client 140 via network 130. Program function 113 can receive information reflective of the ready status of test client 140. Program function 113 determines the ready status of test client 140.

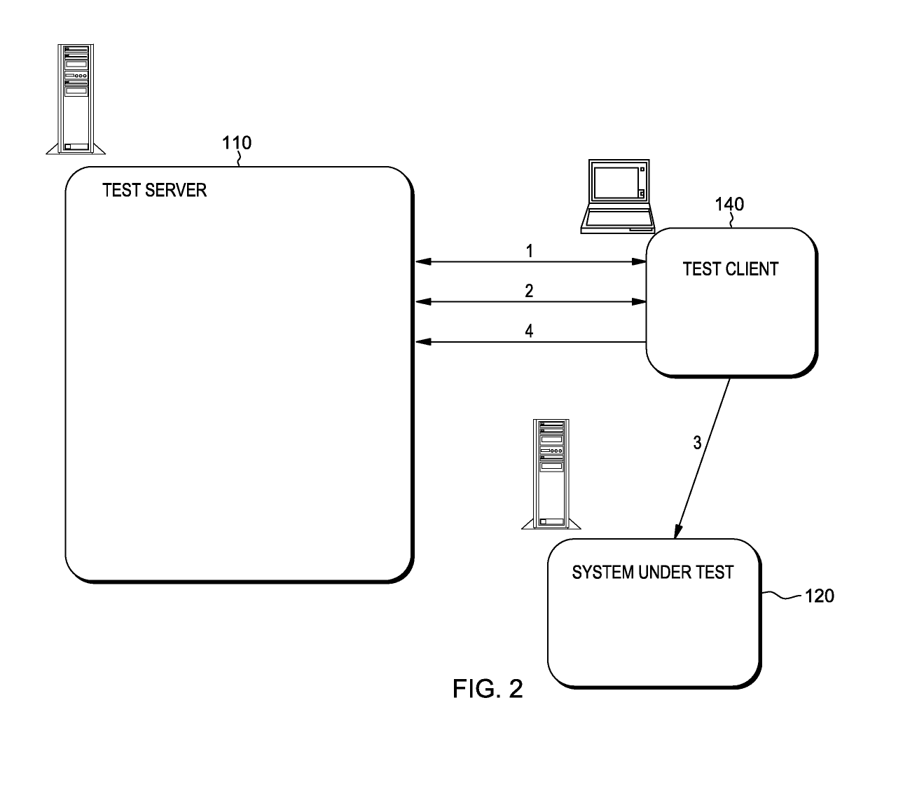

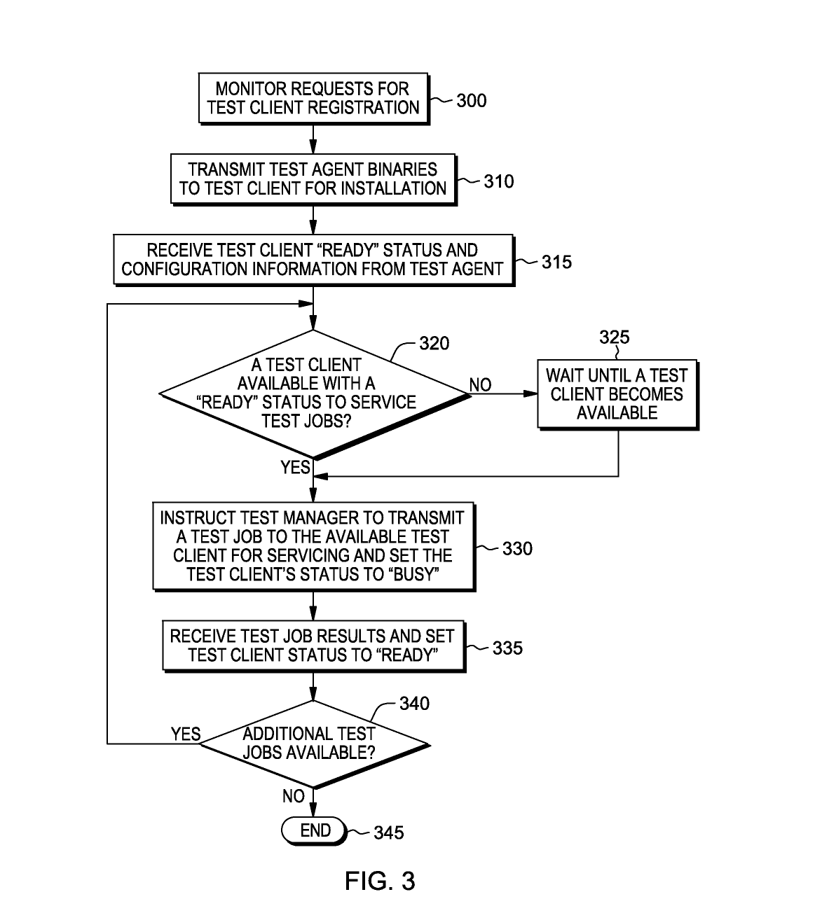

Concepts introduced in the following discussion of FIG. 2 will be used further in the discussion of FIG. 3 in the context of environment 100 of FIG. 1. FIG. 2 is a depiction of various push/pull cycles (hereinafter “cycles”) and transmissions between the test server, test client, and system under test of FIG. 1, in accordance with an embodiment of the present invention. Specifically, FIG. 2 illustrates an embodiment of the present invention wherein a particular test job file is serviced by an idle processor included in a computer grid environment and a report that includes the results thereof generated. Program function 113 decreases software development time by using the idle CPUs of test clients to service predefined test jobs, in accordance with an embodiment of the present invention.

Cycle 1 initiates when test client 140 transmits, via network 130, a request to become a test client to program function 113 and concludes when program function 113 transmits a test agent binary file that is included in test agent binary files 115 to test client 140 for installation therein. Cycle 2 initiates when test agent 142 notifies program function 113 that test client 140 is ready (a test client is ready when its ready status indicates that it is prepared to perform a test) to accept test jobs, the location and/or identity of the test client, and the system configuration of test client 140. In an embodiment, test client 140 is ready to receive a test job when the usage rate of its CPU(s) falls below a predetermined value/amount, for example, 10%.

Cycle 2 concludes when a test job is available in test job files 118 and program function 113 instructs test manager 112 to transmit, via network 130, the test job to test agent 142 for servicing. As per transmission 3, test agent 142 sets up the test environment, which may include installing and booting SUT 120 and/or booting any necessary test support systems and starting services on those systems. For example, if a test job tested user authentication via a directory server and the test job included logging in a particular user to a directory server, then the directory server is the test support system. In an embodiment, test support systems 122 can be external to SUT 120.

As per transmission 4, subsequent to the servicing of the test job by test agent 142, test agent 142 transmits the results to program function 113, which instructs test manager 112 to store the test results in test job results files 117. In an embodiment, test manager 112 generates a test report using test results stored in test job results files 117.

FIG. 3 is a flowchart depicting operational steps of program function 113, on test server 110 within the environment of FIG. 1, for using idle CPUs to test software that is under development, in accordance with an embodiment of the present invention. Program function 113 monitors requests for test client registration (step 300). Program function 113 transmits test agent binaries to the test client for installation (step 310). Program function 113 receives notification to set the test client's status to “ready” and test client configuration information test agent 142 (step 315). If program function 113 determines that there are no test clients available with a “ready” status to service test jobs (“no” branch decisional 320), then program function 113 waits until a test client with a “ready” status become (step 325) and proceeds to step 330 (discussed below).

If program function 113 determined that there is at least one test client available with a “ready” status (“yes” branch decisional 320), program function 113 sets test client's status to “busy” and instructs test manager 112 to transmit a test job to the available test client (step 330). Program function 113 receives the test job results and sets test client's status to “ready” (step 335). If program function 113 determines that there are additional test jobs available for servicing (“yes” branch decisional 340), then program function 113 returns to step 320. If program function 113 determines that there are no additional test jobs available for servicing (“no” branch decisional 340), then program function 113 stops (step 345).

FIG. 4 depicts a block diagram of components of test server 110 and test client 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Test server 110 and test client 140 includes communications fabric 402, which provides communications between computer processor(s) 404, memory 406, persistent storage 408, communications unit 410, and input/output (hereinafter “I/O”) interface(s) 412. Communications fabric 402 can be implemented with any architecture designed for passing data and/or control information between processors (such as microprocessors, communications, and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (hereinafter “RAM”) 414 and cache memory 416. In general, memory 406 can include any suitable volatile or non-volatile computer-readable storage media.

Test manager 112, program function 113, exemplary repository 114, and testing repository 116 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (hereinafter “ROM”), an erasable programmable read-only memory (hereinafter “EPROM hereinafter”), a flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of test server 110, SUT 120, and test client 140. In these examples, communications unit 410 includes one or more network interface cards. Communications unit 410 may provide communications through the use of either or both physical and wireless communications links. Test manager 112, program function 113, and test agent 112 may be downloaded to persistent storage 408 through communications unit 410.

I/O interface(s) 412 allows for input and output of data with other devices that may be connected to test server 110, test client 140, and SUT 120. For example, I/O interface(s) 412 may provide a connection to external devices 418 such as a keyboard, a keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., test manager 112, program function 113, exemplary repository 114, and testing repository 116, can be stored on such portable computer-readable storage media and can be loaded onto persistent storage 408 via I/O interface(s) 412. I/O interface(s) 412 also connects to a display 420. Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
transmitting, by one or more computer processors, a test job to a test client for servicing, wherein the test client has an idle resource;
receiving, by the one or more computer processors, results of the test job servicing from the test client;
wherein the test job includes computer code that is under development and predefined information that reflects how the test client is to execute the test job.

2. The method of claim 1, wherein the test job boots a system under test associated with the test job.

3. The method of claim 1, wherein the transmitted test job allows the test client to boot a test support component required for servicing.

4. The method of claim 1, wherein the idle resource is a CPU or network.

5. The method of claim 1, wherein the idle resource has a usage rate at or below a predetermined amount.

6. The method of claim 3, wherein the test job allows the test client to access the test support component for servicing without utilizing the one or more computer processors.

7. The method of claim 1, wherein the one or more computer processors is part of a heterogenous computing grid.
